(19) United States
(12) Patent Application Publication
(10) Pub. No.: US 2012/0297619 A1
(43) Pub. Date: Nov. 29, 2012

(54) METHOD OF PRODUCING HOLLOW CASTING AND METHOD OF PRODUCING PISTON OF INTERNAL COMBUSTION ENGINE

(75) Inventors: Kimihiko Ando, Toyota-shi (JP); Yuki Kamo, Anjo-shi (JP)

(73) Assignee: TOYOTA JIDOSHA KABUSHIKI KAISHA, Toyota-shi, Aichi (JP)

(21) Appl. No.: 13/577,854

(22) PCT Filed: Feb. 25, 2010
(86) PCT No.: PCT/JP2010/052927

§ 371 Date: Aug. 8, 2012

(51) Int. Cl. B22D 19/00; B23P 15/10

(52) U.S. Cl. 29/888.047; 29/527.4

(57) ABSTRACT

A method of producing a hollow casting is provided, by which the joinability of a cast base material and a hollow-forming member to each other can be enhanced while suppressing the generation of oxides of or blow holes on a casting base material. The method of producing the hollow casting comprises enveloping a hollow-forming member in a molten base-metal cast material. Specifically, the method comprises the steps of: producing a hollow-forming member with a material having a melting point higher than that of a base-metal cast material such that air-gap layers are formed within the surface layers of contact surfaces with which the molten metal comes into contact; coating the contact surfaces with a layer of the same metal as that of the base-metal cast material; and enveloping the hollow-forming member in the base-metal cast material by disposing the coated hollow-forming member within a mold and then pouring the molten base-metal cast material into the mold.

### TECHNICAL FIELD

The present invention relates to a method of producing a hollow casting with an internal cavity for heat insulation purposes and the like, such as a heat-insulated piston of an internal combustion engine.

### BACKGROUND ART

In order to produce a hollow casting with an internal cavity for heat insulation purposes and the like, such as a heat-insulated piston of an internal combustion engine, a hollow-forming member that has a hollow portion with the same shape as the cavity to be formed is disposed in advance in a mold, a molten base-metal cast material is poured into the mold, and thus the hollow-forming member is enveloped in the base-metal cast material.

The hollow-forming member is generally made of material (different material) having a melting point higher than that of a base-metal cast material. Specifically, the hollow-forming member comprises a sintered body such as alumina having a partially open hollow portion and a closure member made of, for example, a stainless steel plate secured to the main body in an integrated manner so as to seal the open part of the hollow portion.

To secure the shape of the hollow portion during casting, for example, a solid substance (e.g., lead or thermoplastic resin) that is solid at normal temperature and becomes gasified or melted at a temperature below the melting point of the base-metal cast material during casting may be used for filling (For example, refer to Patent Document 1.)

A coating layer (e.g., a metal layer such as a plated layer) of a metal material equivalent to a base-metal cast material is often provided on the surface of a hollow-forming member before casting. When the hollow-forming member provided with such coating layer is enveloped in the base-metal cast material, the heat of the molten base-metal cast material melts the metal layer, so that the base-metal cast material can be welded to the hollow-forming member.

Patent Document 1: JP Patent Publication (Kokoku) No. 3-9821 B (1991).

### DISCLOSURE OF THE INVENTION

### Problems to be Solved by the Invention

The molten metal temperature of a molten base-metal cast material is preferably further increased to melt a metal layer of a hollow-forming member with the molten base-metal cast material, so as to ensure sufficient melting of the metal of the metal layer together with the base-metal cast material. However, as the molten metal temperature increases, the base-metal cast material is oxidized or blow holes become easily formed on the casting base material, which may decrease the quality of shaped castings.

In view of the foregoing circumstances, the hollow-forming member is preferably enveloped in the molten base-metal cast material without excessively increasing the molten metal temperature. However, in such a case, the heat of the molten metal surrounding the hollow-forming member is transmitted into the hollow-forming member at the moment the molten metal comes into contact with the hollow-forming member, so that the surrounding molten metal is locally cooled. As a result, the metal layer cannot be sufficiently melted with the heat of the molten metal, so that the casting base material and the hollow-forming member are unable to be welded and joined.

The present invention is made in view of the foregoing circumstances. An object of the present invention is to provide a method of producing a hollow casting that can increase joinability of a casting base material and a hollow-forming member to each other while suppressing the formation of oxides of or blow holes on casting base materials.

### Solution to Problem

The present inventors have obtained new findings below through extensive experimentation and research with a view to solving the problems mentioned above. Specifically, if a heat-insulating layer is provided on the surface layer of a hollow-forming member so as to prevent the heat of a molten base-metal cast material from being transferred to the interior of the hollow-forming member, the molten metal temperature around the hollow-forming member during casting is maintained at a level almost equivalent to the other molten metal temperature. Hence, the metal layer on the surface of the hollow-forming member can be melted with the molten metal without further increasing the molten metal temperature, and joinability of the casting base material and the hollow-forming member to each other can be increased.

The present invention is achieved based on these new findings obtained by the present inventors. The present invention relates to a method of producing a hollow casting by enveloping a hollow-forming member in a molten base-metal cast material. The method comprises at least the steps of:
producing the hollow-forming member with a material having a melting point higher than that of the base-metal cast material, so that an air-gap layer is formed inside the surface layer of the contact surface with which the molten metal comes into contact;
coating the contact surface with a layer of the same metal as the base-metal cast material; and
enveloping the hollow-forming member in the base-metal cast material by disposing the coated hollow-forming member within a mold and then pouring the molten base-metal cast material into the mold.

According to the present invention, first, through the step of producing a hollow-forming member, a hollow-forming member can be obtained in which air-gap layers are formed inside the surface layers of contact surfaces (to be enveloped) that come into contact with a molten base-metal cast material.

Here, the air-gap layers located inside the surface layers of the contact surfaces are hollow heat-insulating layers that are each formed within a sealed space so as to insulate the heat that is transmitted to the inner part from the contact surfaces of the hollow-forming member. The air-gap layers are preferably located closer to the contact surfaces, as long as mechanical strength can be ensured upon casting into a hollow casting or upon use as a hollow casting.

The hollow-forming member can be produced by joining a main body in which a recess or a groove portion corresponding to an air-gap layer is formed with a closure portion for the formation of the air-gap layer by covering the opening of the recess or the groove portion, for example.

Here, the term “hollow-forming member” in the present invention refers to a member in which cavities are formed. In the present invention, each cavity corresponds to an air-gap layer and the air-gap layer corresponds to the cavity of the enveloped hollow casting.

Next, in the coating step, the contact surfaces of the hollow-forming member are coated with layers made of the same metal as that of the base-metal cast material by coating treatment such as plating treatment or sputtering treatment. Here, the term “the same metal as that of the base-metal cast material” refers to a metal made of a base material that is the same as the base-metal cast material. For example, when the base-metal cast material is an aluminium alloy, the metal of the metal layer comprises aluminium as a chief material. As long as the metal of a metal layer can be sufficiently melted in a base-metal cast material upon enveloping, the other ingredients added thereto may differ.

As described above, the thus obtained hollow-forming member is disposed within a mold, the molten base-metal cast material is poured into the mold, and then the base-metal cast material is caused to come into contact with the contact surfaces prepared by forming air-gap layers in the surface layers of the hollow-forming member, so that the hollow-forming member is enveloped.

At this time, the air-gap layers act as heat-insulating layers against the heat of the molten metal surrounding the hollow-forming member. Hence, even if the molten metal comes into contact with the hollow-forming member, the heat of the surrounding molten metal is transmitted with difficulty to the interior of the hollow-forming member. As a result, the interface temperature between the metal layer applied to the hollow-forming member and the base-metal cast material (molten metal) can be maintained at a level at which they can be welded or higher. Thus, the metal layer is melted and then the base-metal cast material and the metal layer form a uniform structure, so that the hollow-forming member and the base-metal cast material can be welded.

Furthermore, upon the use of the thus obtained hollow casting, the air-gap layers formed in the surface layers of the hollow-forming member can be caused to act as heat-insulating layers for the hollow casting.

The hollow-forming member can be produced with any metal material as long as: it has a melting point higher than the molten metal temperature of the base-metal cast material when a hollow casting is produced using the hollow-forming member; and it is stable to the molten base-metal cast material.

For example, when the base-metal cast material is an aluminium-based metal such as an aluminium alloy, an iron-based metal, a titanium-based metal, a ceramic, or the like is more preferably used for the hollow-forming member. Such a metal is preferable since it has a higher melting point and a lower thermal conductivity than an aluminium-based metal. When iron-based metal is used, the hollow-forming member can be obtained by sintering iron-based powder, mechanically processing an iron-based bulk material, or casting with a mold, for example. Examples of such an iron-based metal include metal material such as carbon steel, stainless steel, and Fe—Mn alloy.

When these materials are selected, in the step of producing a hollow-forming member, it is more preferable to produce the hollow-forming member so that the thickness of each air-gap layer is 0.3 mm or greater. Provision of air-gap layers having such layer thickness can further ensure the insulation from the heat of the molten base-metal cast material.

Furthermore, in the method of producing a hollow casting according to the present invention, a hollow-forming member is more preferably produced under a vacuum atmosphere. A hollow-forming member is produced so that air-gap layers of the hollow-forming member are in a vacuum state. Thus, the heat insulating properties of the air-gap layers can be enhanced. Also, since the air-gap layers are in a vacuum state, upon casting, air within the air-gap layers (that is, sealed space) will never abruptly expand due to the heat of the molten metal, and the hollow-forming member will almost never swell.

It is more preferable to produce a piston of an internal combustion engine by the method of producing a hollow casting according to the present invention. In the enveloping step, the hollow-forming member is more preferably enveloped in the base-metal cast material, so that the hollow-forming member is disposed at the top of the piston.

According to the present invention, a hollow-forming body is disposed at the top of the piston, so as to prevent heat release via the piston from the interior of the combustion chamber of an internal combustion engine. Thus, heat insulating properties of the combustion chamber are enhanced. As a result, vaporization of a fuel supplied to the combustion chamber is accelerated, so that the discharge of unburned gases can be suppressed.

### Advantageous Effects of the Invention

According to the present invention, joinability of a casting base material and a hollow-forming member to each other can be increased while suppressing the formation of oxides of or blow holes on the casting base material.

### BRIEF DESCRIPTION OF THE DRAWINGS

FIG. 1 is a diagram illustrating the steps of producing a hollow-forming member to be used in the method of producing a hollow casting according to an embodiment of the present invention. FIG. 1(a) is a cross-sectional view showing the main body of a hollow-forming member. FIG. 1(b) is a diagram illustrating the state of the main body of a hollow-forming member to which a closure portion is attached.

FIG. 2 is a diagram illustrating a step of coating the hollow-forming member shown in FIG. 1 with a metal layer.

FIG. 3 is a diagram illustrating a step of enveloping the hollow-forming member shown in FIG. 2 in a molten base-metal cast material.

FIG. 4 is a diagram showing a piston of an internal combustion engine, which is produced by the method of producing a hollow casting according to an embodiment of the present invention.

FIG. 5 shows photographs showing a cross-sectional view of the structure of the hollow casting. FIG. 5(a) is a photograph showing a portion near the peripheral surface of the hollow-forming member according to Example 1 and the cast base material. FIG. 5(b) is a photograph showing a portion near the peripheral surface of the hollow-forming member according to Comparative example 1 and the casting base material.

FIG. 6 is a diagram illustrating a test piece used in Example 2 and Comparative example 2.

FIG. 7 is a diagram showing the relationship between the thickness of an air-gap layer and effective thermal conductivity in Example 2 and Comparative example 2.

### BEST MODE FOR CARRYING OUT THE INVENTION

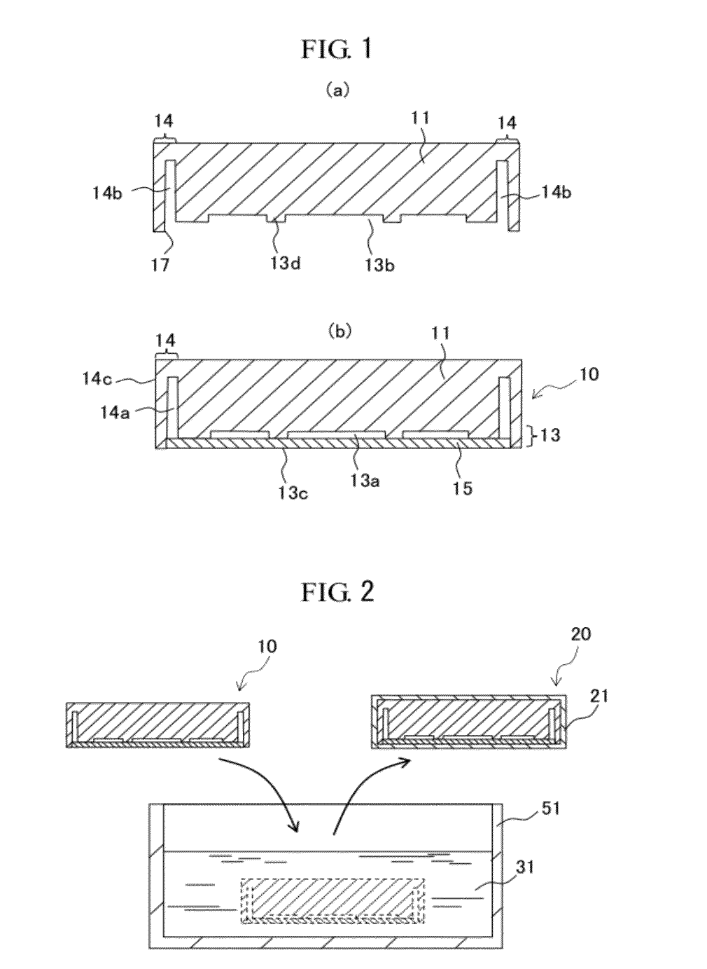

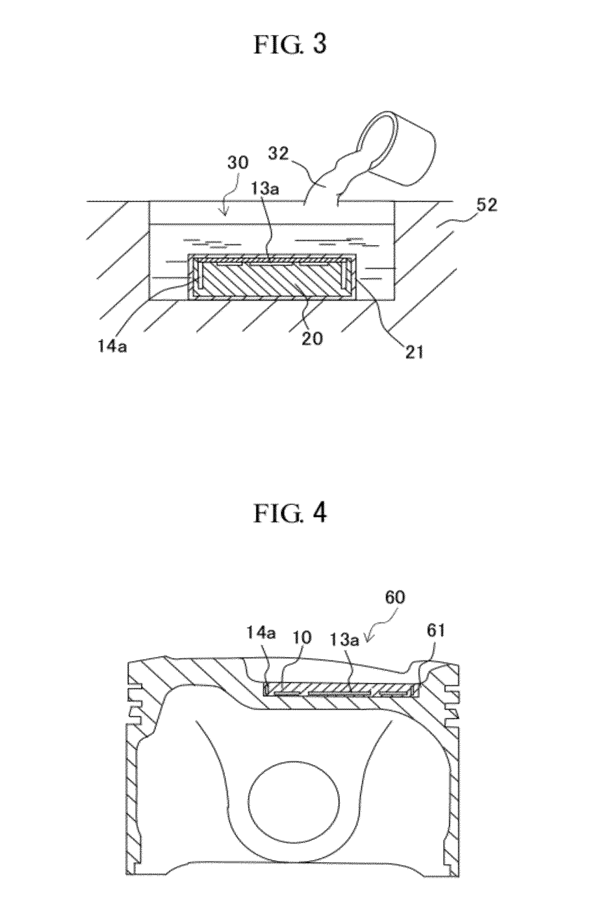

An embodiment according to the present invention is described below with reference to the drawings. FIG. 1 is a diagram illustrating the steps of producing a hollow-forming member to be used in the method of producing a hollow casting according to an embodiment of the present invention. FIG. 1 (a) is a cross-sectional view showing the main body of a hollow-forming member. FIG. 1 (b) is a diagram illustrating the state of the main body of a hollow-forming member to which a closure portion is attached. FIG. 2 is a diagram illustrating a step of coating the hollow-forming member shown in FIG. 1 with a metal layer. FIG. 3 is a diagram illustrating a step of enveloping the hollow-forming member shown in FIG. 2 in a molten base-metal cast material.

As shown in FIG. 1 (a) and (b), a hollow-forming member 10 according to this embodiment comprises a main body 11 and a closure portion 15. The main body 11 is cylindrical in shape, and a discoidal hollow recess 13b is formed therein such that the interior of a bottom-face surface layer 13 serves as an air-gap layer 13a and such that the bottom face side is partially open, on the lateral side, a cylindrical hollow groove portion 14b is formed such that the interior of the lateral surface layer 14 serves as an air-gap layer 14a.

Such main body 11 may be produced by mechanically processing cylindrical metal, or it may be produced as illustrated in FIG. 1 (a), for example. Alternatively, such main body 11 may be produced by filling the cavity of a mold shaped as illustrated in FIG. 1 (a) with sintering powder for shaping and then sintering the shaped article.

Here, in this embodiment, since an aluminium-based metal (aluminium alloy) is used for a base-metal cast material described later, a hollow-forming member is produced using iron-based metal such as carbon steel, stainless steel, an Fe—Mn alloy, a titanium alloy, or ceramics, as a metal material having a melting point higher than that of an aluminium-based alloy. If an iron-based material is used herein, the hollow recess 13b and the hollow groove portion 14b of the main body 11 are formed so that the layer thickness of the air-gap layers 13a and 14a of the hollow-forming member 10 is 0.3 mm or more.

Moreover, the thickness of the wall portion of the hollow-forming member 10 that is formed between the bottom face (peripheral surface) and the air-gap layers ranges from preferably about 0.5 mm to 2.0 mm such that the mechanical strength of the hollow-forming member and the hollow casting can be ensured.

In addition, a ring-shaped rib 13d is formed in a protruding manner in the hollow recess 13b of the main body 11. With the use of the rib 13d, positioning is possible to prevent the closure portion 15 from entering the hollow recess 13b. Moreover, when a hollow casting is created and then used as a hollow casting, the hollow-forming member 10 can be reinforced so as to prevent the air-gap layer 13a on the bottom face side of the hollow-forming member 10 from being deformed.

Next, a discoidal closure portion 15 made of iron is joined with the bottom face side by brazing so as to cover the opening 17 of the main body 11 as shown in FIG. 1(b). Therefore, as described later, the air-gap layer 13a is formed within a circular bottom face (contact surface) 13c of the bottom-face surface layer 13 with which the molten base-metal cast material 32 comes into contact, and the air-gap layer 14a is formed within a peripheral surface (contact surface) 14c of the lateral surface layer 14 with which the molten base-metal cast material 32 comes into contact (see FIG. 3).

When the main body 11 and the closure portion 15 are joined, brazing (vacuum brazing) is performed more preferably under a vacuum atmosphere, so as to vacuumize the air-gap layers 13a and 14a (by which air is prevented from entering). As described above, the hollow-forming member 10 is produced so as to vacuumize the air-gap layers 13a and 14a of the hollow-forming member 10, so that the heat insulating properties of the air-gap layers can be enhanced.

Furthermore, thermal expansion of air in the air-gap layers 13a and 14a can be suppressed by the production method. Specifically, the air-gap layers 13a and 14a are in a vacuum state, so that upon casting, the air-gap layers 13a and 14a, which are sealed spaces, do not rapidly expand because of the heat of molten metal and air therewithin. Accordingly, the hollow-forming member will almost never swell upon casting.

Next, as shown in FIG. 2, the hollow-forming member 10 is immersed in a bath 51 containing molten metal 31 that is the same aluminium-based metal as the base-metal cast material. Coating with a metal layer (plated layer) 21 is performed by conducting about 1 to 2 minutes of aluminizing (plating processing). In FIG. 2, all surfaces of the hollow-forming member 10 are subjected to plating processing. However, in the case of this embodiment, on the surface of the hollow-forming member 10, at least the bottom face 13c and the peripheral surface 14c with which the molten base-metal cast material 32 comes into contact are coated with a metal layer 21.

Also, the layer thickness of the metal layer 21 preferably ranges from about 0.02 to 0.2 mm, and such range is not particularly limited as long as the molten base-metal cast material 32 can be melted so that adhesion between the casting base material and the hollow-forming member can be ensured.

In addition, here the hollow-forming member 10 is immersed in the molten metal 31 in which aluminium-based metal has been melted, and then plating processing is performed. Coating with the metal layer 21 may be performed by electroplating processing, sputtering treatment, or the like.

Furthermore, as shown in FIG. 3, a hollow-forming member 20 coated with a metal layer 21 is disposed within a mold 52 and then a molten base-metal cast material 32 is poured into the mold, thereby enveloping the hollow-forming member 20 in the base-metal cast material. The resultant is left to stand to cool and then the material is removed from the mold as a hollow casting 30.

At this time, the air-gap layers 13a and 14a act as heat-insulating layers against the heat of the molten metal (molten base-metal cast material) 32 surrounding the hollow-forming member 20. Even when the molten metal 32 comes into contact with the hollow-forming member 20, the heat of the surrounding molten metal 32 is transmitted with difficulty into the hollow-forming member 20. As a result, the interface temperature between the metal layer 21 applied to hollow-forming member 20 and the molten base-metal cast material 32 is maintained at a temperature at which welding thereof is possible or higher. Therefore, the metal layer 21 is melted and then the base-metal cast material and the metal of the metal layer form a uniform structure, so that the hollow-forming member and the base-metal cast material can be welded and joinability of the two to each other can be enhanced.

Moreover, when the thus obtained hollow casting 18 is used, the air-gap layers 13a and 14a formed in the bottom-face surface layer 13 and lateral surface layer 14 of the hollow-forming member 20 act as heat-insulating layers for the hollow casting 18.

FIG. 4 shows a piston 60 of an internal combustion engine, which is produced by the above production method so that cavities formed by the air-gap layers 13a and 14a of the hollow-forming member 10 serve as heat-insulating portions. In the enveloping step, the piston 60 is casted by pouring the molten base-metal cast material into a mold (not shown) within which the hollow-forming member 10 is disposed at the top portion 61 of the piston 60. At this time, the air-gap layers 13a and 14a of the hollow-forming member 10 function as heat-insulating portions.

As described above, combustion heat within a combustion chamber of the internal combustion engine is prevented from being released via the piston, thereby enhancing heat insulating properties within the combustion chamber. As a result, fuel vaporization can be accelerated and the discharge of unburned gases can be suppressed.

### EXAMPLES

The present invention is described by the following Examples. In addition, the present invention is not limited to the following Examples.

### Example 1

### (Step of Producing Hollow-Forming Member)

Iron-based alloy powder containing manganese, reduced iron powder, and black lead were mixed at a weight ratio of 50:49:1 so that manganese in the alloy accounted for 25% by mass of the iron and carbon in the alloy accounted for 1% by mass of the iron. The material was shaped into a disc with 800 MPa, so that it had a diameter of 40 mm, a height of 10 mm, a groove with a thickness of 0.3 mm provided on the lateral surface layer, and a level difference of 0.3 mm on the bottom face. Next, the shaped article was sintered under heat conditions of 1250° C. for 30 minutes in an argon atmosphere, so that a main body was produced as shown in FIG. 1 (a).

Next, as a closure portion, a disc with a thickness of 0.5 mm made of stainless steel (JAPANESE INDUSTRIAL STANDARDS (JIS): SUS304) was fitted onto the bottom face of a thermal insulating board, and then the contact parts were joined by vacuum copper brazing, so that 0.3-mm-thick air-gap layers were formed within the bottom-face surface layer and the lateral surface layer of the main body.

(Step of Coating with Metal Layer)

A hollow-forming member was immersed in a molten aluminium alloy for casting (JAPANESE INDUSTRIAL STANDARDS (JIS): AC3A) at 725° C. and such condition was maintained for 2 minutes. Thus, the surface of the hollow-forming member was coated with an aluminium alloy metal layer (plated layer).

### (Step of Enveloping)

The hollow-forming member was set in the mold in which the aluminium alloy metal layer had been formed and then enveloped in a molten aluminium alloy for casting (JAPANESE INDUSTRIAL STANDARDS (JIS): AC8A) at 750° C. After the heat of the molten metal within the mold had been released, the thus obtained casting was removed from the mold so that the hollow casting was obtained.

### Comparative Example 1

A hollow casting was produced in the same manner as in Example 1, except that no groove portion was provided within the lateral surface layer during production of a hollow-forming member. Specifically, the thus obtained hollow casting had no air-gap layer within the lateral surface layer as shown in FIG. 1 (b).

### <Observation of Structure>

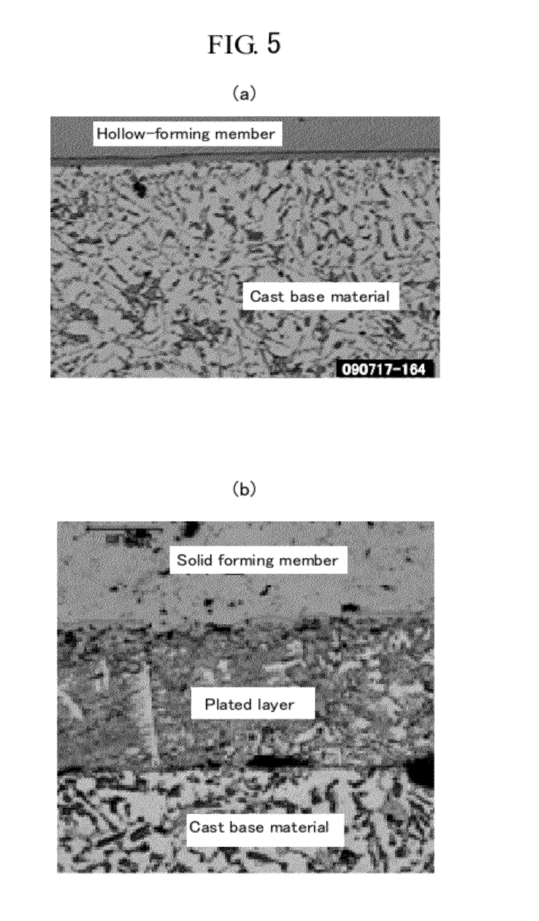

The metal structures of cross sections of the hollow castings in Example 1 and Comparative example 1 were observed using a microscope. FIG. 5 shows the results. In addition, FIG. 5 (a) is a photograph showing the area near the peripheral surface of the hollow-forming member and the casting base material according to Example 1. FIG. 5 (b) is a photograph showing the area near the peripheral surface of the hollow-forming member and the casting base material according to Comparative example 1.

### <Result 1>

As shown in FIG. 5 (a), when an air-gap layer was provided in the lateral surface layer of the hollow-forming member (Example 1), an aluminium alloy metal layer was melted together with a casting base material (molten metal), so that the metal layer was integrated with the casting base material. Meanwhile, when no air-gap layer was provided in the lateral surface layer of the hollow-forming member (Comparative example 1), an aluminium alloy metal layer was not melted together with a casting base material and a gap was observed between the metal layer and the casting base material.

### <Evaluation 1>

It is considered based on result 1 that in the case of Example 1, the lateral air-gap layer acted as a heat-insulating layer against the heat of molten metal surrounding the hollow-forming member, the metal layer applied to the hollow-forming member was melted together with the molten base-metal cast material, the base-metal cast material and the metal of the metal layer formed a uniform structure, and thus the hollow-forming member and the base-metal cast material could be welded.

### Example 2

In a manner similar to that in Example 1, iron-based alloy powder, reduced iron powder, and black lead were mixed at a weight ratio of 50:49:1 so as to achieve Fe-25% by mass and Mn-1% by mass C. The material was then shaped with 800 MPa into a disc having a diameter of 65 mm and a thickness of 10 mm. Next, the shaped article was sintered under heat conditions of 1250° C., 30 minutes, and an argon atmosphere, so that a sintered body was produced. The thus sintered body was cut into a sintered plate having a size of 24 mm×24 mm and a thickness of 1.7 mm.

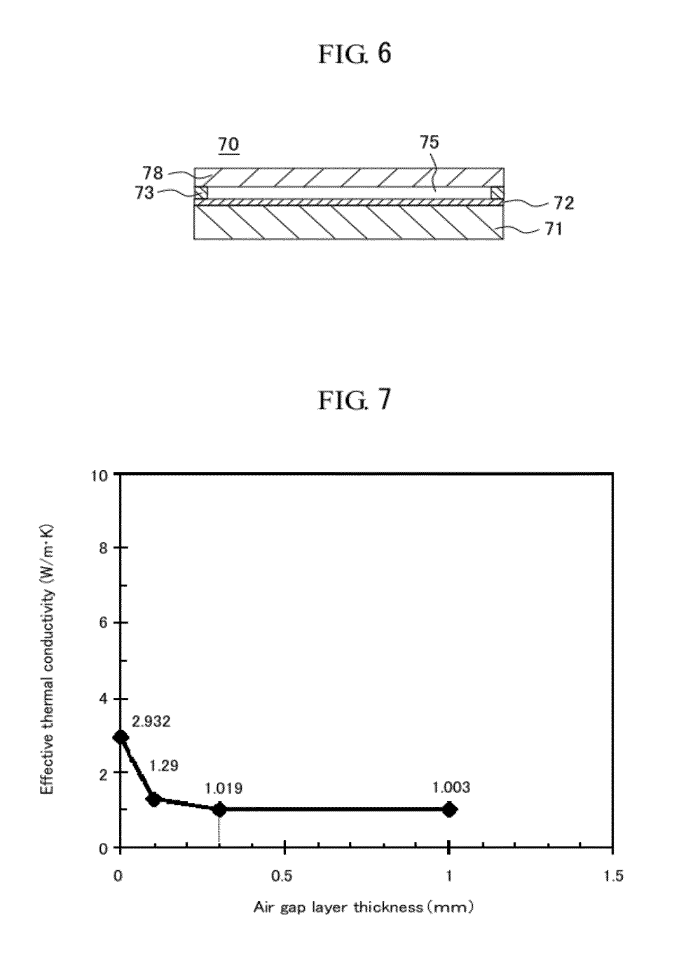

As shown in FIG. 6, a 3-mm-thick aluminium alloy for casting (JAPANESE INDUSTRIAL STANDARDS (JIS): AC8R) 71 and a 0.5-mm-thick stainless steel plate (JAPANESE INDUSTRIAL STANDARDS (JIS): SUS304) 72 were laminated. Next, a spacer 73 made of stainless steel having a width of 1 mm and a thickness of 0.1 mm, 0.3 mm, or 1.0 mm was disposed on the stainless steel plate 72. A test piece of the sintered plate 78 was brazed on the spacer 73, so that an air-gap layer 75 having a layer thickness equivalent to the thickness of the spacer 73 was formed. Hence, a specimen 70 corresponding to a hollow casting was prepared.

### Comparative Example 2

A specimen was prepared in the same manner as that in Example 2, except that a stainless steel plate 72 and the sintered plate 78 were directly brazed without mediation of the spacer 73 made of stainless steel, and specifically, no air-gap layer was formed (layer thickness of 0 mm).

### <Test for Evaluation of Thermal Conductivity>

A constant thermal conductance measuring device (ULVAC, Inc.) was used. Specifically, specimens of Example 2 and Comparative example 2 were each placed between an upper heater and a lower heater within the device and adjustment was made using a guard heater so as to provide a predetermined temperature difference to form a one-dimensional heat flux. The heat flux at the time was measured and then effective thermal conductivity was determined based on the calibration value and the thickness of each specimen. FIG. 7 shows the results.

### <Result 2>

As shown in FIG. 7, air-gap layers were formed through provision of a spacer made of stainless steel. As a result, the effective thermal conductivity of each specimen was decreased. Furthermore, as in Example 2, the rate of reduction in effective thermal conductivity decreased when the layer thickness of an air-gap layer was 0.1 mm or more, but it was found to be constant when the same was 0.3 mm or more.

### <Evaluation 2>

It can be said based on result 2 that the layer thickness of an air-gap layer is preferably 0.3 mm or greater in order for air-gap layers to act as heat-insulating layers and thus to ensure stable heat insulating properties.

While the embodiments of the present invention have been described in detail above, the present invention is by no means limited to the embodiments discussed above, and various design modifications may be made without departing from the spirit of the present invention as defined in the claims.

For example, cylindrical hollow-forming members were used in the embodiments, but the shape thereof is not limited to the shape. Hollow-forming members may be shaped corresponding to portions of a hollow casting for which increased heat insulating properties are expected. Examples of such a shape that may be employed herein include a polygonal column and an elliptical column. Also, in the embodiments, air-gap layers were provided in the surface layers of the surfaces with which molten metal comes into contact. Cavities may further be provided in other portions in which heat insulating properties are desirably enhanced.

### EXPLANATION OF REFERENCE

10; hollow-forming member, 11; main body, 13; bottom-face surface layer, 13a; air-gap layer, 13b; hollow recess, 13c; bottom face, 14; lateral surface layer, 14a; air-gap layer, 14b; hollow groove portion, 14c; peripheral surface, 15; closure portion, 20; hollow-forming member, 21; metal layer, 31; molten metal, 32; molten metal, 51; bath, 52; mold , 60; piston, 61; top portion

1. A method of producing a hollow casting by enveloping a hollow-forming member in a molten base-metal cast material, comprising at least the steps of:
producing the hollow-forming member with a material having a melting point higher than that of the base-metal cast material, so that air-gap layers are formed inside the surface layers of the contact surfaces with which the molten metal comes into contact; coating the contact surfaces with a layer of the same metal as the base-metal cast material; and enveloping the hollow-forming member in the base-metal cast material by disposing the coated hollow-forming member within a mold and then pouring the molten base-metal cast material into the mold.

2. The method of producing a hollow casting according to claim 1, wherein an aluminium-based metal is used as the hollow casting metal and an iron-based metal is used as the hollow-forming member, and in the step of producing the hollow-forming member, the hollow-forming member is produced so that the thickness of each air-gap layer is 0.3 mm or greater.

3. The method of producing a hollow casting according to claim 1, wherein the hollow-forming member is produced under a vacuum atmosphere.

4. A method of producing a piston of an internal combustion engine comprising the method of producing a hollow casting according to claim 1, wherein in the enveloping step, the hollow-forming member is enveloped in the base-metal cast material, so that the hollow-forming member is disposed at the top of the piston.
